(19) United States
(12) Patent Application Publication
(10) Pub. No.: US 2019/0253728 A1
(43) Pub. Date: Aug. 15, 2019

(54) METHOD AND DEVICE FOR VIDEO DATA COMPRESSION

(71) Applicant: Shanghai Xiaoyi Technology Co., Ltd., Shanghai (CN)

(72) Inventor: Xiaohong DI, Shanghai (CN)

(73) Assignee: Shanghai Xiaoyi Technology Co., Ltd., Shanghai (CN)

(21) Appl. No.: 16/262,104

(22) Filed: Jan. 30, 2019

(30) Foreign Application Priority Data
Feb. 9, 2018 (CN) 201810136456.9

(51) Int. Cl. H04N 19/50; H04N 19/182; H04N 19/176

(52) U.S. Cl. CPC H04N 19/50; H04N 19/176; H04N 19/182

(57) ABSTRACT

A method for video data compression including, receiving video data; separating raw pixel data from raw control data in the video data; compressing the raw pixel data to obtain output pixel data; compressing the raw control data to obtain output control data; and integrating the output pixel data and the output control data to obtain bitstream data.

The disclosure claims the benefits of priority to Chinese Application No. 201810136456.9 filed on Feb. 9, 2018, which is incorporated herein by reference in its entirety.

### FIELD OF TECHNOLOGY

The present disclosure relates to the field of video coding and, more specifically, relates to a video data compression method, device, storage medium, and computing device.

### BACKGROUND

Data compression refers to a technical method for reducing data redundancy and storage space under the prerequisite of not losing useful information by reducing data volume or reorganizing data based on a certain algorithm.

With currently available video processing systems, pixel data is processed extensively using compression technology, e.g., H.264 or advanced video coding (AVC), high-efficiency video coding (HEVC), and joint photographic experts group-lossless standard (JPEG-LS). However, a video processing system may also generate a large quantity of control data, e.g., control data generated for a motion vector of a pixel point, for the noise intensity of a pixel, etc. At present, a pixel data compression method cannot be applied to control data because control data has its own data characteristics; consequently, control data tends to be stored directly without undergoing any processing. However, during the process of eliminating noise and performing statistics on the coding for a video or image, as the requirement for the precision of control data increases, the control data might need to be involved in the processing operations of every pixel point. In an actual system, control data will also occupy increasingly more storage space and access bandwidth, possibly affecting system power consumption and lowering system performance.

However, a technical solution that effectively processes control data is still lacking.

### SUMMARY

In accordance with embodiments of the present disclosure, there is provided a method for video data compression, the method comprising: receiving video data; separating raw pixel data from raw control data in the video data; compressing the raw pixel data to obtain output pixel data; compressing the raw control data to obtain output control data; and integrating the output pixel data and the output control data to obtain bitstream data.

In accordance with embodiments of the present disclosure, there is also provided a device for video data compression device, comprising: a receiving module adapted to receive video data and separate raw pixel data from raw control data in the video data; a first compression module adapted to compress the raw pixel data to obtain output pixel data; a second compression module adapted to compress the raw control data to obtain output control data; and an integration module adapted to integrate the output pixel data and the output control data to obtain bitstream data.

### BRIEF DESCRIPTION OF DRAWINGS

FIG. 1 is a flowchart of an exemplary method for video data compression, consistent with disclosed embodiments.

FIG. 2 illustrates a format of bitstream data obtained using a video data compression method, consistent with disclosed embodiments disclosure

FIG. 3 is a block diagram of an exemplary flow of bitstream data obtained using a video data compression method, consistent with disclosed embodiments.

FIG. 4 illustrates an exemplary block diagram of a video data compression device consistent with disclosed embodiments.

### DETAILED DESCRIPTION

As stated in the Background of the disclosure, currently available technology directly transmits control data, occupying a large amount of storage space and access bandwidth, which affects system power consumption and lowers system performance.

The inventor has discovered that, in a video processing system, there are mainly two types of compression for pixel data of video signals: one type is lossless compression, which exploits data redundancy (e.g., spatial redundancy, temporal redundancy, structural redundancy, information entropy redundancy, etc.) and the strong correlation existing between the pixels. The elimination of such redundant information will not result in information loss; consequently, lossless compression may be achieved. The other type is lossy compression, which is achieved by exploiting visual redundancy. Visual redundancy refers to determining data redundancy on the basis of the different levels of sensitivity of the human eye to different brightness levels and colors by exploiting the visual characteristics of the human eye (e.g., brightness discrimination threshold value, visual threshold value). Objective distortion of data information is present when data compression is achieved by reducing data information. When compressing data, if an appropriate level of distortion error is introduced, then it will not be detected by the human eye. It is on the basis of data redundancy and visual redundancy that video data can be processed using compression technology and be compressed to a very large extent. In some embodiments, a pixel compression method is generally based on hybrid coding, i.e., the encoding combines the three methods of transform coding, entropy coding, and motion estimation and motion compensation to achieve data compression. Under normal circumstances, transform coding is used to remove intra-frame redundancy in an image, entropy coding is used to improve compression efficiency, and motion estimation and motion compensation is used to remove inter-frame redundancy. In the pixel compression process, a large amount of control data is produced, and because the characteristics of pixel data and control data differ, if the same compression algorithm is used for both pixel data and control data, then a good result cannot be obtained.

Example embodiments of the present disclosure provides a video data compression method in which, first, video data is received and raw pixel data is separated from raw control data in the video data; second, the raw pixel data is compressed to obtain output pixel data; third, the raw control data is compressed to obtain output control data; and fourth, the output pixel data and the output control data are integrated to obtain bitstream data. The technical solution provided by some embodiments of the present disclosure may separate control data in the video data so that the pixel data and the control data are compressed separately and existing pixel data compression methods do not change. Furthermore, the storage space of the control data may be reduced and the transmission and storage efficiency of the control data are improved.

Thus, a technical problem addressed by the present disclosure is how to effectively compress control data so that it can be used flexibly and efficiently in various types of video image processing.

In order to make the aforementioned purposes, characteristics, and benefits of the present disclosure more evident and easier to understand, detailed descriptions of some embodiments of the present disclosure are provided below with reference to the attached drawings.

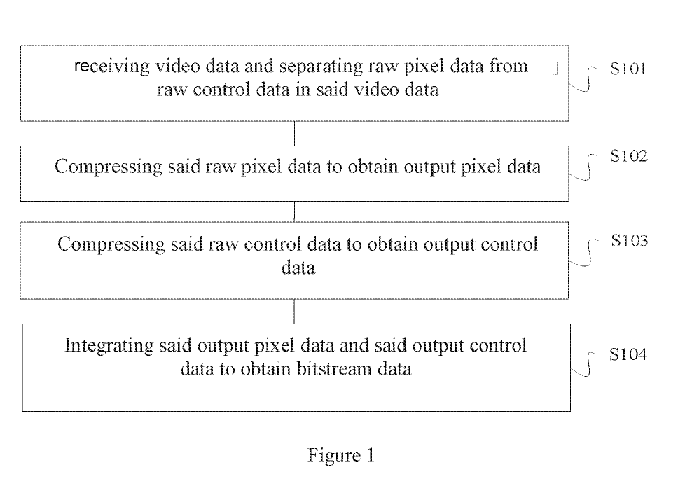

FIG. 1 is a flowchart of an exemplary method for video data compression, consistent with disclosed embodiments the video data may be recorded by a video camera or obtained from video information on the Internet. The video data contains at least pixel data and control data. The video data may be information that has undergone image processing, containing at least pixel data and control data.

After the video data is obtained, compression may be performed on the video data. Specifically, the video data compression method may comprise the following steps:

At S101: receive video data and separate raw pixel data from raw control data in the video data.

At S102: compress the raw pixel data to obtain output pixel data.

At S103: compress the raw control data to obtain output control data.

At S104: integrate the output pixel data and the output control data to obtain bitstream data.

In some embodiments, at S101, after video data is received, raw pixel data may be separated from raw control data in the video data to obtain pixel data and control data. For example, the video data is 16-bit data containing 12 bits of pixel data and 4 bits of control data. Here, pixel data may be unprocessed (raw) image data in Bayer format. The raw image data refers to raw data of digital signals converted from light source signals captured by a CMOS (complementary metal-oxide-semiconductor transistor) or CCD (charge coupled device) image sensor. Control data may be a noise intensity weight coefficient that corresponds to each pixel. For the convenience of illustration, the pixel data obtained from the separation is referred to as raw pixel data, and the control data obtained from the separation is referred to as raw control data.

Then, the raw pixel data and the raw control data may be stored using a respective local storage device of each.

In some embodiments of the present disclosure, one or more local storage devices to store the raw pixel data. The storage space and access settings of each storage device may be selected based on the size of the predictive coding block of the raw pixel data. In one embodiment, the storage space and access settings of each storage device may be stored based on the size of the predictive coding block of the raw control data. The storage space of the local storage device storing the raw pixel data and the storage space of the local storage device storing the raw control data may be the same or different.

At S102, the raw pixel data may be obtained from one of the local storage devices storing the raw pixel data, in order to be compressed. In one embodiment, the raw pixel data may be predicted based on the configured block size using a blocking method and the predicted pixel data is encoded.

More particularly, in some embodiments the compression of the raw pixel data may be performed on data blocks (also referred to as basic unit blocks). The size of each basic unit block may be configured in advance based on the size and application scenario of the image. The size of the basic unit block may be equal to the size of the raw pixel data in the cache of the local storage device. Under normal circumstances, in order to balance compression results and resource expenses, a basic unit block may be configured to be 256 pixels.

After the pixel data based on a unit block is obtained, different prediction methods may be used for prediction on each basic unit block. For example, the prediction method may be differential coding prediction, filtered linear prediction, or another prediction method.

The predicted pixel data may be obtained upon completing the prediction. After a residual of the predicted pixel data is calculated, the pixel data residual may be remapped and encoded to obtain compressed pixel data.

In an exemplary embodiment of the present disclosure, a differential coding prediction method is used by the raw pixel data to complete the prediction. In one embodiment, the first pixel of each basic unit block may be directly stored and transmitted. Starting with the second pixel, each pixel uses the previous pixel as predicted pixel data Pred(n), where n represents the n-th pixel in the basic unit block, and n starts from 0:

$$Pred ( n ) = \{ \begin{matrix}0 , & n = 0 \\ Curr ( n - 1 ) , & n \geq 1\end{matrix} .$$

A residual Res(n) may be calculated based on the current pixel and the predicted pixel data, the residual (e.g., the basic unit block contains 256 raw pixels) is determined by:

Res(n)=Curr(n)−Pred(n),n=0,1, . . . 255.

By remapping the residuals of the pixels in the basic unit block, remapped pixel data Res′(n) may be obtained:

$${Res}^{′} ( n ) = \{ \begin{matrix}- 2 * ( 0 - Res ( n ) ) + 1 , & Res ( n ) < 0 \\ 2 * Res ( n ) , & Res ( n ) \geq 0\end{matrix} .$$

Then, based on the configured size and encoding method of the basic unit block, the remapped pixel data is encoded to obtain the compressed pixel data. During encoding, an encoding method that supports lossless compression or lossy compression may be used. For example, threshold-based Golomb (Rice) coding may be used or Huffman coding may be used, and it is understood by persons having ordinary skill in the art that other video coding methods may also be used; no redundant examples will be cited here.

Further, if the compressed pixel data is obtained, then a comparison may be performed between the raw pixel data and the compressed pixel data, and, based on a bypass mode, the compressed pixel data or the raw pixel data, whichever is smaller in data volume, becomes the output pixel data. Here, the bypass mode may ensure that the compressed data stream will not exceed the raw data stream in order to handle special cases of actual data (e.g., data on which the prediction or compression algorithm fails).

For example, while encoding raw pixel data, it is assumed that a basic unit block contains 256 pieces of pixel data, then the byte count of the raw pixel data is 256*12 bits/pixel/8=384 bytes. If the output byte count of the compressed pixel data is greater than or equal to 384, then the bypass mode may be entered, in which the raw pixel data is used directly to be the output pixel data.

At S103, the raw control data may be similarly obtained from a local storage device to be compressed. In one embodiment, using a blocking method, the raw control data is predicted based on the configured block size and encoding is performed based on the obtained predicted control data.

More particularly, in some embodiments, the compression of the raw control data may be performed using a blocking method. The size of each control data block may be configured based on characteristics of the control data. The size of each raw control data block may be the same as or different from the size of the basic unit block of the raw pixel data, e.g., each raw control data block may be configured to be 512 bytes. It is thus evident that, if the size of the raw control data block is different from the size of the basic unit block of the raw pixel data, then the storage space of the local storage device storing the raw control data also is different from the storage space of the local storage device storing the raw pixel data.

After the raw control data block is obtained, different prediction methods may be used for prediction on each byte of the raw control data block. The prediction method for performing prediction may be differential coding prediction or another prediction method.

The predicted control data may be obtained upon completing the prediction. After a residual of the predicted control data is calculated, the control data residual may be remapped and encoded to obtain compressed control data.

In a non-limiting example embodiment, the raw control data uses a differential coding prediction method to complete the prediction. In one specific embodiment, intra-block prediction may be performed on the raw control data in the control data block. More particularly, in some embodiments, first, the control data associated with the first byte of the control data block is directly stored and transmitted; then, for the other bytes starting with the second byte, each byte uses the previous byte as predicted control data Pred_Intra(n), where n represents the n-th byte in the control data block, and n starts from 0:

$$Pred\_Intra ( n ) = \{ \begin{matrix}0 , & n = 0 \\ Curr ( n - 1 ) , & n \geq 1\end{matrix} .$$

In one exemplary embodiment, inter-block prediction may also be performed based on adjacent control data blocks. For example, inter-block prediction may be performed on control data using characteristics of two adjacent control data blocks. In such case, the n-th piece of predicted control data Pred_Inter(n) (n is a non-negative integer) is:

$$Pred\_Inter ( n ) = \{ \begin{matrix}0 , & n = 0 \\ {Curr}^{′} ( n - 1 ) , & n \geq 1\end{matrix} .$$

For each control data block, the encoded byte count of the intra-block prediction may be calculated, the encoded byte count of the inter-block prediction based on the previous control data block may be calculated, and whichever of the two prediction results that has a smaller byte count may be selected to become the predicted control data Pred_data:

$$Pred\_data = \{ \begin{matrix}{Pred}_{intra} , {Pred}_{intra} & byte count < {Pred}_{inter} byte count \\ {Pred}_{inter} , {Pred}_{intra} & byte count \geq {Pred}_{inter} byte count\end{matrix} .$$

Next, residual Res_data(n) may be calculated based on the current control data and the predicted control data, and the residual Res_data(n) is (e.g., the basic unit block contains 512 raw control data):

Res_data(n)=Curr_data(n)−Pred_data(n),n=0,1, . . . 511

Then, the control residuals of the basic unit block may be remapped to obtain remapped control data Res_data′(n),

$${Res\_data}^{′} ( n ) = \{ \begin{matrix}- 2 * ( 0 - Res\_data ( n ) ) + 1 , & Res\_data ( n ) < 0 \\ 2 * Res\_data ( n ) , & Res\_data ( n ) \geq 0\end{matrix}$$

In some embodiments, based on the configured size and encoding method of the basic unit block, the remapped control data is encoded to obtain the compressed control data. Here, the encoding method may be lossless compression or lossy compression. For example, threshold-based Golomb (Rice) coding may be used or Huffman coding may be used.

Further, if the compressed control data is obtained, then a comparison may be performed between the raw control data and the compressed control data, and, based on the bypass mode, the compressed control data or the raw control data, whichever is smaller in data volume, becomes the output control data.

At S104, the output pixel data and the output control data may be integrated to obtain bitstream data.

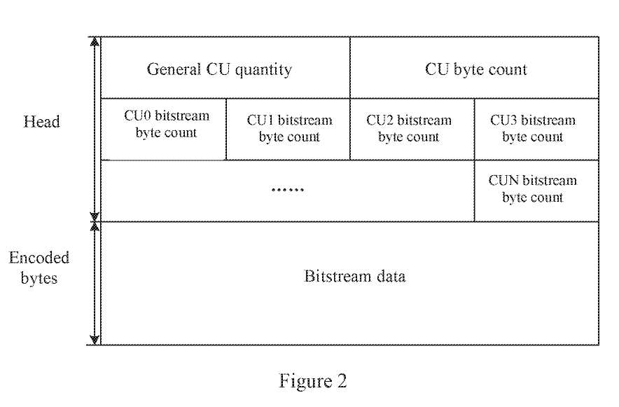

In one non-limiting example embodiment, the bitstream data may be stored in accordance with a bitstream format illustrated in FIG. 2. Referring to FIG. 2, the bitstream format comprises two portions: a head portion and an encoded byte portion. Here, the format of the head portion is 16-bit (i.e., the smallest unit of data is 2 bytes or 16 bits) aligned comprising 4 bytes for a general coding unit (the coding unit, or CU, is used to indicate the size of the compressed pixel data and the size of the compressed control data) quantity, 4 bytes for coding unit size, then the bitstream byte count of a number of corresponding coding units, each CU being 2 bytes (e.g., CU0 bitstream byte count, CU1 bitstream byte count, CU2 bitstream byte count, CU3 bitstream byte count . . . CUN bitstream byte count), and finally the actual bitstream data. The bitstream data is stored sequentially based on the order of the coding units (CU0, CU1 . . . CUN), corresponding to the output pixel data and the output control data. Preferably, after the bitstream data is obtained, the bitstream data may also be stored to await subsequent processing or transmission.

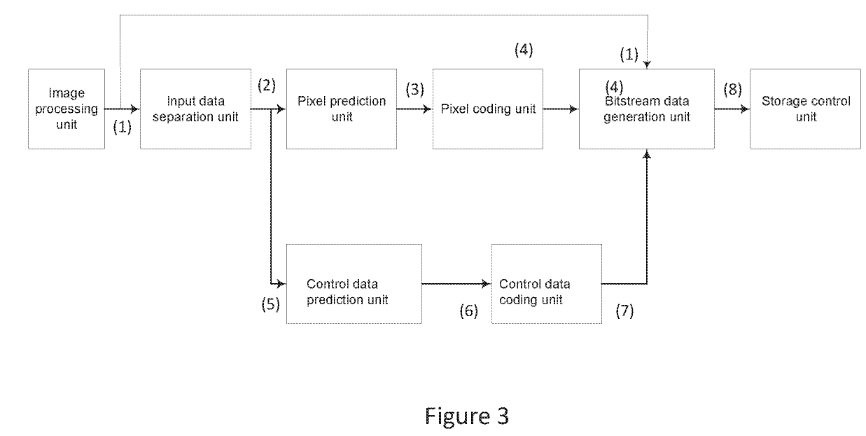

FIG. 3 block diagram of an exemplary flow of bitstream data obtained using a video data compression method consistent with disclosed embodiments.

Referring to FIG. 3, first, an input data separation unit receives video data (1) outputted from an image processing unit, the video data (1) containing raw pixel data (2) and raw control data (5).

Second, the input data separation unit separates the raw pixel data (2) from the raw control data (5) contained in the video data (1), outputs the raw pixel data (2) obtained from the separation to a pixel prediction unit, and, moreover, outputs the raw control data (5) obtained from the separation to a control data prediction unit.

Third, for the raw pixel data (2), the pixel prediction unit, after receiving the raw pixel data (2) provided by the input data separation unit, performs prediction on the raw pixel data (2) based on the configured block size and prediction method and outputs predicted pixel data (3) to a pixel coding unit. After receiving the predicted pixel data (3) provided by the pixel prediction unit, the pixel coding unit performs encoding based on the configured block size and encoding method and obtains compressed pixel data (4). Here, the encoding may support lossless compression or lossy compression.

Similarly, for the raw control data (5), the control data prediction unit, after receiving the control data (5) provided by the input data separation unit, performs prediction on the raw control data (5) based on the configured block size and prediction method, obtains predicted control data (6), and outputs it to a control data coding unit. After receiving the predicted control data (6) provided by the control data prediction unit, the control data coding unit performs encoding based on the configured block size and encoding method and obtains compressed control data (7). The encoding may support lossless compression or lossy compression.

Then, the pixel coding unit outputs the obtained compressed pixel data (4) to an output bitstream data generation unit; and the control data coding unit outputs the obtained compressed control data (7) to the output bitstream data generation unit. Moreover, the bitstream data generation unit also receives the video data (1) outputted by the image processing unit.

Finally, the output bitstream data generation unit compares the raw pixel data (2) contained in the video data (1) and the compressed pixel data (4) to determine the compressed pixel data (4) or the raw pixel data (2) to be the output pixel data. Similarly, the output bitstream data generation unit compares the raw control data (5) contained in the video data (1) and the compressed control data (7) to determine the compressed control data (7) or the raw control data (5) to be the output control data. That is, a selection may be made separately for the pixel data bitstream and the control data bitstream; after the output pixel data and output control data are determined, bitstream data (8) is outputted by the output bitstream data generation unit to a storage control unit; and the storage control unit stores the bitstream data.

As described above, the technical solution of the video data compression method provided by this exemplary embodiment of the present disclosure separately compresses the pixel data and the control data and can reduce the storage space of the control data, improving the transmission and storage efficiency of the control data.

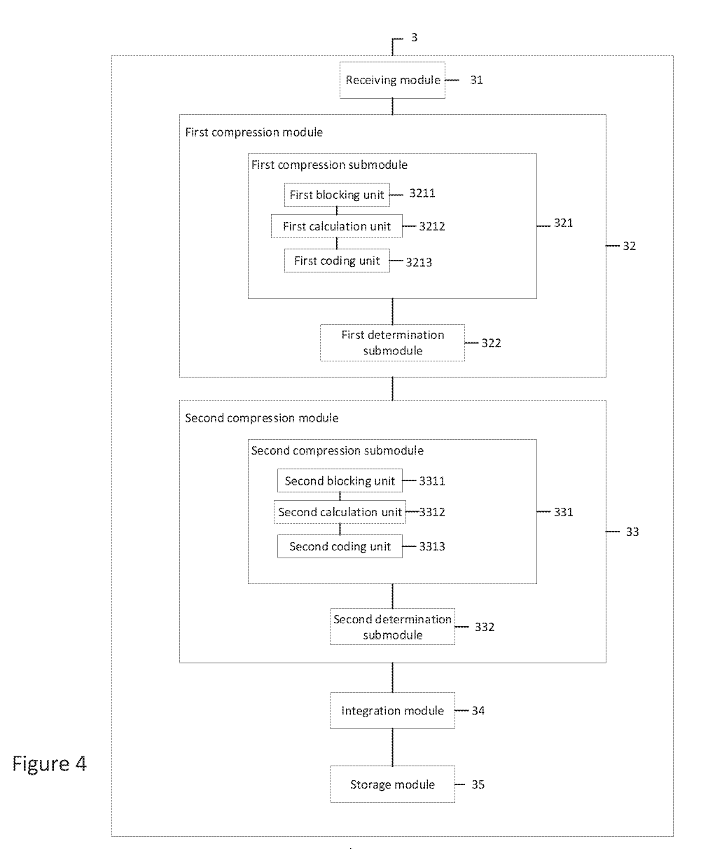

FIG. 4 illustrates an exemplary block diagram of a video data compression device 3 consistent with disclosed embodiments. The video data compression device 3 (hereinafter referred to as compression device 3) may comprise: a receiving module 31, a first compression module 32, a second compression module 33, and an integration module 34.

More particularly, the receiving module 31 is adapted to receive video data and separate the raw pixel data from the raw control data in the video data. The first compression module 32 is adapted to compress the raw pixel data to obtain output pixel data. The second compression module 33 is adapted to compress the raw control data to obtain output control data. The integration module 34 is adapted to integrate the output pixel data and the output control data to obtain bitstream data.

The compression device 3 may further comprise a storage module 35. The storage module 35 is adapted to store the bitstream data.

In one exemplary embodiment, the first compression module 32 may comprise: a first compression submodule 321 and a first determination submodule 322.

In some embodiments, the first compression submodule 321 is adapted to compress the raw pixel data to obtain compressed pixel data. The first determination submodule 322 is adapted to determine, based on the result of a comparison between the raw pixel data and the compressed pixel data, the compressed pixel data or raw pixel data to be the output pixel data.

Further, the first compression submodule 321 may comprise: a first blocking unit 3211, a first calculation unit 3212, and a first coding unit 3213.

More particularly, the first blocking unit 3211 is adapted to perform prediction on the raw pixel data using a blocking method to obtain predicted pixel data. The first calculation unit 3212 is adapted to calculate the residual of the predicted pixel data. The first coding unit 3213 is adapted to remap and encode the residual of the pixel data to obtain the compressed pixel data.

Further, the second compression module 33 may comprise a second compression submodule 331 and a second determination submodule 332.

In one embodiment, the second compression submodule 331 is adapted to compress the raw control data to obtain compressed control data. The second determination submodule 332 is adapted to determine, based on the result of a comparison between the raw control data and the compressed control data, the raw control data or the compressed control data to be the output control data.

Here, the second compression submodule 331 may comprise a second blocking unit 3311, a second calculation unit 3312, and a second coding unit 3313.

More particularly, the second blocking unit 3311 is adapted to perform prediction on the raw control data using a blocking method to obtain predicted control data. The second calculation unit 3312 is adapted to calculate the residual of the predicted control data. The second coding unit 3313 is adapted to remap and encode the residual of the control data to obtain the compressed control data.

Further, when prediction is being performed on the raw control data using the blocking method, the size of the coding block resulting from the blocking is different from the size of the coding block resulting from the blocking of the raw pixel data.

Please refer to the relevant descriptions in FIGS. 1-3 above for more information on the principles and ways of operation for the video data compression device 3. Such descriptions will not be repeated here.

Some embodiments of the present disclosure further provide a storage device, storing computer instructions, which, when executed by a processor cause the processor to perform methods as discussed above with respect to FIGS. 1-3. For example, the storage medium may comprise a computer-readable storage medium such as a non-volatile storage device or a non-transitory storage device. The computer-readable storage medium may comprise a ROM, a RAM, a magnetic disk, or an optical disc, etc.

Some embodiments of the present disclosure further provide a computing device that includes a storage device and a processor; the storage device storing computer instructions, which, when executed by a processor cause the processor to perform methods as discussed above with respect to FIGS. 1-3.

In comparison with currently available technology, the technical solution provided by example embodiments of the present disclosure has the following benefits.

Some embodiments of the present disclosure provide a video data compression method; first, video data is received and raw pixel data is separated from raw control data in the video data; second, the raw pixel data is compressed to obtain output pixel data; third, the raw control data is compressed to obtain output control data; fourth, the output pixel data and the output control data are integrated to obtain bitstream data. The technical solution provided by example embodiments of the present disclosure may separate control data in the video data so that the pixel data and the control data are compressed separately and existing pixel data compression methods do not change; furthermore, the storage space of the control data may be reduced and the transmission and storage efficiency of the control data are improved.

Further, when prediction is being performed on the raw control data using a blocking method, the size of the coding block resulting from the blocking is different from the size of the coding block resulting from the blocking of the raw pixel data. Coding blocks of different sizes may be used in the compression of the raw pixel data and the raw control data, and control data may be compressed on the basis of the characteristics of the control data, further improving the compression efficiency of video data.

Notwithstanding the above disclosure, the present disclosure is not limited thereby. Any person having ordinary skill in the art may make various alterations and changes that are not detached from the essence and scope of the present disclosure; therefore, the scope of protection for the present invention should be that as defined by the claims.

1. A method for video data compression, the method comprising:
receiving video data;
separating raw pixel data from raw control data in the video data;
compressing the raw pixel data to obtain output pixel data;
compressing the raw control data to obtain output control data; and
integrating the output pixel data and the output control data to obtain bitstream data.

2. The method of claim 1, further comprising:
storing the bitstream data.

3. The method of claim 1, wherein compressing the raw pixel data to obtain the output pixel data comprises:
compressing the raw pixel data to obtain compressed pixel data; and
determining the output pixel data to be the raw pixel data or the compressed pixel data based on a result of a comparison between the raw pixel data and the compressed pixel data.

4. The method of claim 3, wherein compressing the raw pixel data to obtain the compressed pixel data comprises:
performing prediction on the raw pixel data using a blocking method to obtain predicted pixel data;
calculating a residual of the predicted pixel data; and
remapping and encoding the residual of the predicted pixel data to obtain the compressed pixel data.

5. The method of claim 4, wherein compressing the raw control data to obtain the output control data comprises:
compressing the raw control data to obtain compressed control data; and
determining the output control data to be the raw control data or the compressed control data based on a result of a comparison between the raw control data and the compressed control data.

6. The method of claim 5, wherein compressing the raw control data to obtain the compressed control data comprises:
performing prediction on the raw control data using a blocking method to obtain predicted control data;
calculating a residual of the predicted control data; and
remapping and encoding the residual of said the predicted control data to obtain the compressed control data.

7. The method of claim 6, wherein, when prediction is being performed on the raw control data using the blocking method, the size of the coding block resulting from the blocking is different from the size of the coding block resulting from the blocking of the raw pixel data.

8. A video data compression device, comprising:
a receiving module adapted to receive video data and separate raw pixel data from raw control data in the video data;
a first compression module adapted to compress the raw pixel data to obtain output pixel data;
a second compression module adapted to compress the raw control data to obtain output control data; and
an integration module adapted to integrate the output pixel data and the output control data to obtain bitstream data.

9. The video data compression device of claim 8, wherein the video data compression device further comprises: a storage module adapted to store the bitstream data.

10. The video data compression device of claim 8, wherein the first compression module comprises:
a first compression submodule adapted to compress the raw pixel data to obtain compressed pixel data; and
a first determination submodule adapted to determine the output pixel data to be the raw pixel data or the compressed pixel data based on the result of a comparison between the raw pixel data and the compressed pixel data.

11. The video data compression device of claim 10, wherein the first compression submodule comprises:
a first blocking unit adapted to perform prediction on the raw pixel data using a blocking method to obtain predicted pixel data;
a first calculation unit adapted to calculate a residual of the predicted pixel data; and
a first coding unit adapted to remap and encode the residual of the predicted pixel data to obtain the compressed pixel data.

12. The video data compression device of claim 11, wherein the second compression module comprises:
a second compression submodule adapted to compress the raw control data to obtain compressed control data; and
a second determination submodule adapted to determine the output control data to be the raw control data or the compressed control data, based on a result of a comparison between the raw control data and the compressed control data.

13. The video data compression device of claim 12, wherein the second compression submodule comprises:
a second blocking unit adapted to perform prediction on the raw control data using a blocking method to obtain predicted control data;
a second calculation unit adapted to calculate a residual of the predicted control data; and
a second coding unit adapted to remap and encode the residual of the control data to obtain the compressed control data.

14. The video data compression device of claim 13, wherein, when prediction is being performed on the raw control data using the blocking method, the size of the coding block resulting from the blocking is different from the size of the coding block resulting from the blocking of the raw pixel data.

15. A storage medium storing instructions which, when executed by a processor, cause the processor to perform the method for video data compression method of claim 1.

16. A storage medium storing instructions which, when executed by a processor, cause the processor to perform the method for video data compression method of claim 7.

17. A non-transitory computer-readable medium storing instructions which, when executed by a processor, cause the processor to perform the method for video data compression of claim 1.

18. A non-transitory computer-readable medium storing instructions which, when executed by a processor, cause the processor to perform the method for video data compression of claim 7.
